(19) United States
(12) Patent Application Publication
(10) Pub. No.: US 2006/0109259 A1
(43) Pub. Date: May 25, 2006

(54) Storage medium storing image display program, image display processing apparatus and image display method

(75) Inventor: Keizo Ohta, Kyoto (JP)

Correspondence Address: NIXON & VANDERHYE, P.C., 901 NORTH GLEBE ROAD, 11TH FLOOR, ARLINGTON, VA, 22203, US

(73) Assignee: Nintendo Co., Ltd., Kyoto (JP)

(21) Appl. No.: 11/274,259

(22) Filed: Nov. 16, 2005

(30) Foreign Application Priority Data
Nov. 19, 2004 (JP) 2004-335747

(51) Int. Cl. G09G 5/00

(52) U.S. Cl. 345/173

(57) ABSTRACT

A game apparatus includes an LCD, a touch panel is provided in association with the LCD. On the LCD, a game screen of a game such as a puzzle game is displayed. It is noted that a part of the puzzle (virtual space) is displayed on the LCD. During the game, a user inputs a character, instructs a desired icon, moves the desired icon on the game screen by performing a touch-input on a first operation area of the touch panel by use of a stick. In addition, the user performs a touch-on operation on the second operation area of the touch panel by use of the stick and according to a drag operation to allow the screen displayed on the LCD to be scrolled in the dragged operation.

### CROSS REFERENCE OF RELATED APPLICATION

The disclosure of Japanese Patent Application No. 2004-335747 is incorporated herein by reference.

### BACKGROUND OF THE INVENTION

1. Field of the Invention

The present invention relates to a storage medium storing an image display processing program, an image display processing apparatus, and an image display method. More specifically, the present invention relates to a storage medium storing an image display processing program, an image display processing apparatus, and an image display method that render an image in response to an operation input, or performs a predetermined process set in advance on a displayed image.

2. Description of the Prior Art

One example of this kind of a conventional image display processing apparatus is disclosed in a Japanese Patent No. 3228584 [G06F 3/03, G06F 3/033] registered on Sep. 7, 2001. According to this prior art, when a frame of a touch panel is touched, a display image is scrolled.

However, in the prior art, it is possible to scroll a screen only in any one of eight directions of left, right, up, down, upper left, upper right, lower left and lower right, and therefore, a user cannot arbitrarily determine a scroll direction. Furthermore, in the prior art, every time that a touch-operation is performed, the screen is scrolled by a predetermined amount. Thus, if a touch-continued operation (repeat input) is not allowable, it is necessary to touch the screen many times in order to scroll a long distance. In addition, if the repeat input is allowable, scrolling the screen is performed by a predetermined amount, making it difficult to adjust a scroll amount. That is, it may not be the that it is superior to operability.

### SUMMARY OF THE INVENTION

Therefore, it is a primary object of the present invention to provide a novel storage medium storing an image display processing program, image display processing apparatus, and image display method.

Another object of the present invention is to provide a storage medium storing an image display processing program, an image display processing apparatus, and an image display method that are able to improve operability.

A storage medium storing an image display processing program according to the present invention stores an image display processing program of an image display processing apparatus. The image display processing apparatus is provided with a display to display a partial area in a virtual space, and renders, according to an operation input, an image or performs a predetermined process set in advance on a displayed image. The image display processing program causes a process of the image display processing apparatus to execute an operation position detecting step, a determining step, an image processing step, and a display area moving step. The operation position detecting step detects an operation position on a screen of the display on the basis of the operation input. The determining step determines in which area the operation position detected by the operation position detecting step is included, a first display area or a second display area that is included in a display area of the display. The image processing step renders an image on the basis of the operation position, or performs a predetermined process set in advance on the image corresponding to the operation position when it is determined that the operation position is included in the first display area by the determining step. The display area moving step moves an area displayed on the display area out of the virtual space according to the movement of the operation position when it is determined that the operation position is included in the second display area by the determining step.

More specifically, the image display processing apparatus (10: a reference numeral corresponding in the embodiment, and so forth) is provided with the display (14) to display the partial area of the virtual space (200). The image display processing apparatus renders an image, or executes a predetermined process set in advance on a displayed image according to the operation input by the user. The image display processing program causes the processor (42) of the image display processing apparatus to execute the following steps. The operation position detecting step (S7) detects the operation position on the screen of the display on the basis of the operation input. Here, the operation input includes arbitrary pointing devices. For example, in a case of utilizing a computer mouse, a mouse pointer is displayed on the screen, and by moving the mouse pointer according to the movement of the computer mouse on the screen, it is determined that there is an operation input according to the presence of the click operation (at a time of the click-on) to thereby detect an operation position at that time. Furthermore, in a case of utilizing a touch panel, it is determined that there is an operation input at a time of presence of the touch input (at a time of the touch-on) to thereby detect the operation position corresponding to the touched position (touched coordinate). The determining step (S13) determines in which area the operation position detected by the operation position detecting step is included, the first display area (102) or the second display area (104). The image processing step (S15, S25) renders an image on the basis of the operation position, or performs the predetermined process set in advance on the image corresponding to the operation position when the operation position is included in the first display area. Furthermore, the display area moving step (S23) moves the area displayed on the display area (102,104) out of the virtual space according to the movement of the operation position, that is, the drag operation by the user when the operation position is included in the second display area.

According to the present invention, it is possible to move the area displayed on the display area according to the drag operation by the user, eliminating a need of a troublesome operation, and capable of performing the operation with ease. That is, it is possible to improve operability.

In one embodiment of the present invention, the display area moving step determines a moving amount of the area displayed on the display area according to a moving amount of the operation position. More specifically, the display area moving step determines the moving amount of the area to be displayed on the display area according to the moving amount of the operation position, that is, the length of the drag operation. Accordingly, for example, in a case that the image (screen) to be displayed on the display area is scrolled by the display area moving step, the scroll amount is determined according to the distance of the drag operation. For example, the scroll amount can be set so as to be equal to the distance of the drag operation, and it may be longer or shorter than the distance by multiplying a predetermined ratio by the distance. That is, the area displayed on the display area can be moved according to the distance of the drag operation by the user.

In another embodiment of the present invention, the display area moving step moves the area displayed on the display area in a direction reverse to a moving direction of the operation position. More specifically, the display area moving step moves the area to be displayed on the display area in the direction reverse to the direction of the moving direction of the operation position, that is, the drag operation. For example, in a case that the image (screen) to be displayed on the display area is scrolled by the display area moving step, the scroll direction is determined according to the direction of the drag operation. Accordingly, it is possible to move the area to be displayed on the display area according to a direction of the drag operation by the user.

In another embodiment of the present invention, the display area moving step moves the area displayed on the display area according to the movement of the operation position only when the operation position at a start of the operation input is included in the second display area. More specifically, the display area moving step moves the area displayed on the display area according to the movement of the operation position only when the operation position at a start of the operation input is included in the second display area. The starting point of the operation input here means that a click-off state is shifted to a click-on state in a case of utilizing the computer mouse, and means that a touch-off state is shifted to a touch-on state in a case of utilizing the touch panel. Accordingly, for example, in a case that the operation position at a start of the operation input is included in the first display area, or in a case that the operation position moves from the first display area to the second display area, the area displayed on the display area of the display is never moved. That is, only when the operation position at a start of the operation input is included in the second display area, the area displayed on the display area is moved according to the drag operation, saving the inconvenience of a screen undesired by the user being displayed.

In one aspect of the present invention, the display area moving step, while the presence of the operation input continues, continues to move the area displayed on the display area according to the movement of the operation position even if the operation position is included in the first display area. More specifically, the display area moving step, while the presence of the operation input continues, that is, the drag operation is continued, continues to move the area displayed on the display area according to the movement of the operation position even if the operation position is included in the first display area. That is, in a case that the operation position at a start of the operation input is included in the second display area, scrolling the screen by the drag operation is continued until the operation input is ended (be subjected to a click-off or touch-off operation). Accordingly, this eliminates a case of an image not intended by the user being displayed.

In another embodiment of the present invention, a screen relating to an image processing is changeably displayed on the first display area, and a specific image is fixedly displayed on the second display area. More specifically, the screen relating to the image processing is displayed on the first display area. That is, it is possible to scroll the screen relating to the image processing. On the other hand, the specific image is fixedly displayed on the second display area. For example, since an image in a single color is displayed, the user can view the second display area on which the operation input (instructed) is performed in order to start the drag operation. Thus, the specific image is displayed on the second display area, capable of preventing an erroneous operation.

In the other embodiment of the present invention, a screen relating to an image processing is changeably displayed on the first display area and the second display area, and a specific image is displayed on the second display area in a translucent manner. More specifically, the screen relating to the image processing is changeably displayed on the first display area and the second display area. It is noted that the specific screen is displayed in a translucent manner on the second display area. Thus, it is possible to effectively utilize the display surface of the display, and to prevent the erroneous operation by the user due to the translucent display at the second display area.

In a further embodiment of the present invention, the first display area is set in a certain definite range including a center of the display surface of the display, and the second display area is set so as to surround the first display area. More specifically, the first display area is set to the certain definite range including the center of the display surface on the display. Furthermore, the second display area is set so as to surround the first display area. Accordingly, in a case that the operation position at a start of the operation input is located in the center of the screen, it is possible to execute an image processing while in a case that the operation position at a time of the operation input is located in the area except for the center, it is possible to execute a display area moving process. That is, merely changing the operation position at a start of the operation input allows execution of different operations, capable of improving operability.

In another aspect of the present invention, the image display processing apparatus is further provided with a touch panel provided in association with the display, wherein the operation position detecting step detects the operation position corresponding to a touched coordinate detected on the basis of an output from the touch panel. More specifically, the image display processing apparatus is further provided with the touch panel (22) provided in association with the display. Accordingly, the operation position detecting step detects the operation position (touch position) corresponding to the touched coordinate detected on the basis of the output from the touch panel. That is, it is possible for the user to operate the game apparatus by a touch operation (touch input). Thus, it is possible to render an image, scroll the screen, and so forth by a touch input, capable of improving operability.

In one embodiment of the present invention, to the touch panel, a first operation area is fixedly set in correspondence to the first display area, and a second operation area is fixedly set in correspondence to the second display area, and the determining step determines that the operation position is included in the first display area when the touched coordinate is included in the first operation area, and determines that the operation position is included in the second display area when the touched coordinate is included in the second operation area. More specifically, to the touch panel, the first operation area (120) is fixedly set in correspondence to the first display area, and the second operation area (122) is fixedly set in correspondence to the second display area. Accordingly, when the touched coordinate is included in the first operation area, it is determined that the operation position is included in the first display area by the determining step. On the other hand, when the touched coordinate is included in the second operation area, it is determined that the operation position is included in the second display area by the determining step. Thus, the first operation area and the second operation area are fixedly set to the touch panel, and therefore, and therefore, it is possible to perform the similar operation irrespective of the display contents. That is, it is possible to improve operability.

Another storage medium storing an image display processing program according to the present invention stores the image display processing program of an image display processing apparatus. The image display processing apparatus is provided with a display to display a partial area in the virtual space and a touch panel provided in association with the display, and renders, in correspondence to the touch input, an image or performs a predetermined process set in advance on a displayed image. The image display processing program executes a processor of the image display processing apparatus to execute a touched coordinate detecting step, a determining step, an image processing step, and a display area moving step. The touched coordinate detecting step detects a touched coordinate on the basis of the output from the touch panel. The determining step determines in which area the touched coordinate detected by the touched coordinate detecting step is included, a first operation area or a second operation area that is set to the touch panel. The image processing step, when it is determined that the touched coordinate is included in the first operation area by the determining step, renders an image on the basis of the touched coordinate, or performs a predetermined process set in advance on the image corresponding to the touched coordinate. The display area moving step, when it is determined that the touched coordinate is included in the second operation area by the determining step, moves an area displayed on the display area of the display in the virtual space according to the movement of the touched coordinate.

In another storage medium also, it is possible to improve operability similar to the invention of the above-described storage medium.

The other storage medium storing an image display processing program according to the present invention stores the image display processing program of an image display processing apparatus. The image display processing apparatus is provided with a display to display a partial area in the virtual space and a touch panel provided in association with the display, and renders, according to the touch input, an image on the virtual space or performs a predetermined process set in advance on the image in the virtual space. The image display processing program causes a processor of the image display processing apparatus to execute a first data storing and updating step, a display data output step, a display control step, a touched coordinate detecting step, a determining step, an image processing step, and a display area moving step. The first data storing and updating step stores and updates first data defining a range to be displayed on the display out of the virtual space. The display data output step outputs display data to display the partial area of the virtual space on the basis of image data to display the virtual space and the first data. The display control step displays the partial area of the virtual space on the display on the basis of the display data output by the display data output step. The touched coordinate detecting step detects a touched coordinate on the basis of an output from the touch panel. The determining step determines in which area the touched coordinate detected by the touched coordinate detecting step is included, a first operation area or a second operation area that is set to the touch panel. The image processing step, when it is determined that the touched coordinate is included in the first operation area by the determining step, renders an image on the basis of the touched coordinate in the virtual space by updating the image data to display the virtual space, or performs a predetermined process set in advance on the image corresponding to the touched coordinate within the virtual space. The display area moving step, when it is determined that the touched coordinate is included in the second operation area by the determining step, moves the partial area to be displayed on the display out of the virtual space by updating the first data by the first data storing and updating step according to the movement of the touched coordinate.

More specifically, the image display processing apparatus (10) is provided with the display (14) to display the partial area in the virtual space (200) and the touch panel (22) provided in association with the display. The image display processing apparatus renders, according to the touch input, an image or performs a predetermined process set in advance on a displayed image. The image display processing program causes a processor (42) of the image display processing apparatus to execute following steps. The first data storing and updating step (S43, S53) stores or updates the first data (482g) defining the range to be displayed on the display out of the virtual space. The first data is, for example, data (coordinate data) as to the center of interest of the virtual camera in the virtual space. The display data output step (S27) outputs the image data (482c) to display the virtual space and the display data to display a partial area in the virtual space on the basis of the first data. The display control step (S29) displays on the display the partial area of the virtual space on the basis of the display data output by the display data output step. The touched coordinate detecting step (S7) detects the touched coordinate on the basis of the output from the touch panel. The determining step (S13) determines to which area the touched coordinate detected by the touched coordinate detecting step is set, the first operation area (120) or the second operation area (122) of the touch panel is included. The image processing step (S15, S25), when it is determined that the touched coordinate is included in the first operation area by the determining step, renders an image on the basis of the touched coordinate in the virtual space by updating the image data to display the virtual space, or performs a predetermined process set in advance on the image corresponding to the touched coordinate within the virtual space. The display area moving step (S23), when it is determined that the touched coordinate is included in the second operation area by the determining step, moves the partial area to be displayed on the display out of the virtual space by updating the first data by the first data storing and updating step according to the movement of the touched coordinate, that is, updating the center of interest of the virtual camera.

In the other storage medium according to the present invention, it is possible to improve operability similar to the invention of the above-described storage medium.

A further storage medium storing an image display processing program according to the present invention stores an image display processing program of an image display processing apparatus. The image display processing apparatus is provided with a display to display a partial screen in a virtual space in which at least a first object and a second object are arranged, and a touch panel provided in association with the display, and renders, according to a touch input, an image or performs a predetermined process set in advance on a displayed image. The image display processing program causes a processor of the image display processing apparatus to execute a touched coordinate detecting step, a determining step, an image processing step, and a display area moving step. The touched coordinate detecting step detects a touched coordinate on the basis of an output from the touch panel. The determining step determines in which area the touched coordinate detected by the touched coordinate detecting step is included, a first display area arranging the first object or a second display area arranging the second object. The image processing step, when it is determined that the touched coordinate is included in the first display area by the determining step, renders an image on the basis of the touched coordinate, or performs a predetermined process set in advance on the image corresponding to the touched coordinate. The display area moving step, when it is determined that the touched coordinate is included in the second display area by the determining step, moves an area to be displayed on a display area of the display out of the virtual space according to the movement of the touched coordinate.

In the further storage medium according to the present invention, unlikely to the storage medium according to each of the above-described inventions, the image processing or the display area moving processing are executed depending on in which area of the virtual space the touched coordinate is included. More specifically, the first object (202) and the second object (204) are arranged in the virtual space. The determining step determines in which area the touched coordinate detected by the touched coordinate detecting step is included, the arranging area of the first object or the arranging area of the second object. The image processing step, when the touched coordinate is included in the first display area (102) by the determining step, renders, on the basis of the touched coordinate, an image or performs a predetermined process set in advance on the image corresponding to the touched coordinate. In addition, the display area moving step, when the touched coordinate is included in the second display area (104), moves the area to be displayed on the display area of the display out of the virtual space according to the movement of the touched coordinate, that is, according to the drag operation by the user.

In the further storage medium according to the present invention, it is possible to improve operability similar to the invention of the above-described storage medium.

The image display processing apparatus according to the present invention is provided with a display to display a partial area of a virtual space, and renders, according to an operation input, an image or performs a predetermined process set in advance on a displayed image. The image display processing apparatus comprises an operation position detecting means, a determining means, an image processing means, and a display area moving means. The operation position detecting means detects an operation position on a screen of the display on the basis of the operation input. The determining means determines in which area the operation position detected by the operation position detecting means is included, a first display area or a second display area that is included in a display area of the display. The image processing means, when it is determined that the operation position is included in the first display area by the determining means, renders an image on the basis of the operation position, or performs a predetermined process set in advance on the image corresponding to the operation position. The display area moving means, when it is determined that the operation position is included in the second display area by the determining means, moves an area displayed on the display area out of said virtual space according to the movement of the operation position.

Another image display processing apparatus according to this invention is provided with a display to display a partial area of a virtual space and a touch panel provided in association with the display, and renders, according to a touch input, an image or performs a predetermined process set in advance on a displayed image. The image display processing apparatus comprises a touched coordinate detecting means, a determining means, an image processing means, and a display area moving means. The touched coordinate detecting means detects a touched coordinate on the basis of the output from the touch panel. The determining means determines in which area the touched coordinate detected by the touched coordinate detecting means is included, a first operation area or a second operation area that is set to the touch panel. The image processing means, when it is determined that the touched coordinate is included in the first operation area by the determining means, renders an image on the basis of the touched coordinate, or performs a predetermined process set in advance on the image corresponding to the touched coordinate. The display area moving means determining means, when it is determined that the touched coordinate is included in the second operation area by the determining means, moving an area displayed on the display area of the display in the virtual space according to the movement of the touched coordinate.

The other image display processing apparatus according to the present invention is provided with a display to display a partial area of a virtual space and a touch panel provided in association with the display, and renders, according to a touch input, an image in the virtual space or performs a predetermined process set in advance on the displayed image in the virtual space. The image display processing apparatus comprises a first data storing and updating means, a display data output means, a display control means, a touched coordinate detecting means, a determining means, an image processing means, and a display area moving means. The first data storing and updating means stores or updates first data defining a range to be displayed on the display out of the virtual space. The display data output means outputs display data to display a partial area of the virtual space on the basis of the image data to display the virtual space and the first data. The display control means displays the partial area of the virtual space on the display on the basis of the display data output by the display data output means. The touched coordinate detecting means detects a touched coordinate on the basis of the output from the touch panel. The determining means determines in which area the touched coordinate detected by the touched coordinate detecting means is included, a first operation area or a second operation area that is set to the touch panel. The image processing means, when it is determined that the touched coordinate is included in the first operation area by the determining means, renders an image in the virtual space on the basis of the touched coordinate by updating the image data to display the virtual space, or performs a predetermined process set in advance on the image corresponding to the touched coordinate within the virtual space. The display area moving means, when it is determined that the touched coordinate is included in the second operation area by the determining means, moves the partial area to be displayed on the display out of the virtual space by updating the first data by the first data storing and updating means according to the movement of the touched coordinate.

A further image display processing apparatus according to the present invention is provided with a display to display a partial screen in a virtual space in which at least a first object and a second object are arranged and a touch panel provided in association with the display, and renders, according to a touch input, an image or performs a predetermined process set in advance on a displayed image. The image display processing apparatus comprises a touched coordinate detecting means, a determining means, an image processing means, and a display area moving means. The touched coordinate detecting means detects a touched coordinate on the basis of an output from the touch panel. The determining means determines in which area the touched coordinate detected by the touched coordinate detecting means is included, a first display area arranging the first object or a second display area arranging the second object. The image processing means, when it is determined that the touched coordinate is included in the first display area by the determining means, renders an image on the basis of the touched coordinate, or performs a predetermined process set in advance on the image corresponding to the touched coordinate. The display area moving means, when it is determined that the touched coordinate is included in the second display area by the determining means, moves an area to be displayed on a display area of the display out of the virtual space according to the movement of the touched coordinate.

In these inventions of the image display processing apparatus also, it is possible to improve operability similar to the invention of the above-described storage medium.

An image display method according to the present invention is an image display method of an image display processing apparatus. The image display processing apparatus is provided with a display for displaying a partial area of a virtual space, and renders, according to an operation input, an image or performs a predetermined process set in advance on a displayed image. The image display method includes (a) detecting an operation position on a screen of the display on the basis of the operation input, (b) determining in which area the operation position detected by the step (a) is included, a first display area or a second display area that is included in a display area of the display, (c) rendering an image on the basis of the operation position, or performing a predetermined process set in advance on the image corresponding to the operation position when it is determined that the operation position is included in the first display area by the step (b), and (d) moving an area displayed on the display area out of the virtual space according to the movement of the operation position when it is determined that the operation position is included in the second display area by the step (b).

An image display method according to the present invention is an image display method of an image display processing apparatus. The image display processing apparatus is provided with a display to display a partial area of a virtual space and a touch panel provided in association with the display, and renders, according to a touch input, an image or performs a predetermined process set in advance on a displayed image. The image display method includes (a) detecting a touched coordinate on the basis of an output from the touch panel, (b) determining in which area the touched coordinate detected by the step (a) is included, a first operation area or a second operation area that is set to the touch panel, (c) rendering an image on the basis of the touched coordinate, or performing a predetermined process set in advance on the image corresponding to the touched coordinate when it is determined that the touched coordinate is included in the first operation area by the step (b), and (d) moving an area displayed on the display area of the display in the virtual space according to the movement of the touched coordinate when it is determined that the touched coordinate is included in the second operation area by the step (b).

An image display method according to the present invention is an image display method of an image display processing apparatus. The image display processing apparatus is provided with a display to display a partial area of a virtual space and a touch panel provided in association with the display, and renders, according to a touch input, an image in the virtual space or performs a predetermined process set in advance on the displayed image in the virtual space. The image display method includes (a) storing and updating first data defining a range to be displayed on the display out of the virtual space, (b) outputting display data to display the partial area of the virtual space on the basis of image data to display the virtual space and the first data, (c) displaying the partial area of the virtual space on the display on the basis of the display data output by the step (b), (d) detecting a touched coordinate on the basis of the output from the touch panel, (e) determining in which area the touched coordinate detected by the step (d) is included, a first display area or a second display area that is set to the touch panel, (f) rendering an image in the virtual space on the basis of the touched coordinate by updating the image data to display the virtual space, or performing a predetermined process set in advance on the image corresponding to the touched coordinate within the virtual space when it is determined that the touched coordinate is included in the first display area by the step (e), and (g) moving the partial area to be displayed on the display out of the virtual space according to the movement of the touched coordinate by updating the first data by the first data storing and updating step when it is determined that the touched coordinate is included in the second display area by the step (e).

A further image display method according to the present invention is an image display method of an image display processing apparatus. The image display processing apparatus is provided with a display to display a partial screen of a virtual space in which at least a first object and a second object are arranged and a touch panel provided in association with the display, and renders, according to a touch input, an image or performs a predetermined process set in advance on the displayed image. The image display method includes (a) detecting a touched coordinate on the basis of an output from the touch panel, (b) determining in which area the touched coordinate detected by the step (a) is included, a first display area arranging the first object and a second display area arranging the second object, (c) rendering an image on the basis of the touched coordinate, or performing a predetermined process set in advance on the image corresponding to the touched coordinate when it is determined that the touched coordinate is included in the first display area by the step (b), and (d) moving an area to be displayed on a display area of the display out of the virtual space according to the movement of the touched coordinate when it is determined that the touched coordinate is included in the second display area by the step (b).

In the invention of these image display methods also, it is possible to improve operability similar to the invention of the above-described storage medium.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing one example of a game apparatus of the present invention;

FIG. 2 is a block diagram showing an electric configuration of the game apparatus shown in FIG. 1;

FIG. 3 is an illustrative view showing an example of a game screen and an example of a touch operation;

FIG. 4 is an illustrative view showing one example of a first operation area and a second operation area that are set to a touch panel;

FIG. 5 is an illustrative view showing a display range in a virtual space of the LCD, and another example of a game screen corresponding to the display range of the LCD;

FIG. 6 is a conceptual rendering showing a drag operation in the virtual space and an illustrative view showing a movement of the center of interest according to the drag operation;

FIG. 7 is an illustrative view showing a memory map of a RAM integrated in the game apparatus shown in FIG. 2;

FIG. 8 is a flowchart showing an image displaying process by a CPU core shown in FIG. 2;

FIG. 9 is a flowchart showing an initialization process of a scrolling process by the CPU core shown in FIG. 2;

FIG. 10 is a flowchart showing a scrolling process by the CPU core shown in FIG. 2;

FIG. 11 is an illustrative view showing a determination area for determining a start of scrolling in a virtual space coordinates system; and

FIG. 12 is an illustrative view showing another example of the game screen to be displayed on the LCD.

### DETAILED DESCRIPTION OF THE PREFERRED EMBODIMENTS

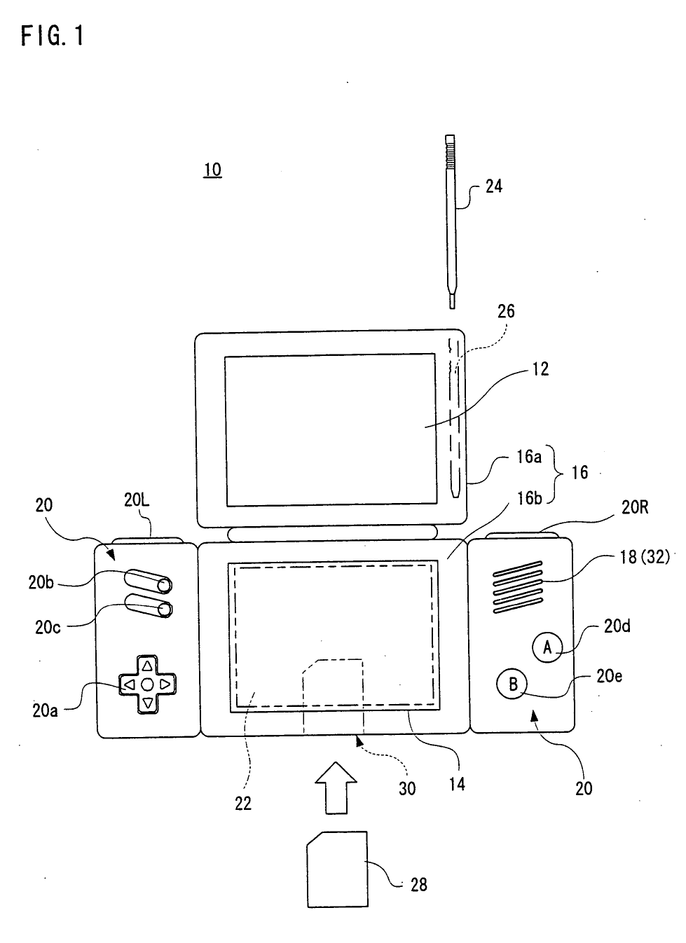

Referring to FIG. 1, a game apparatus 10 of one embodiment of the present invention stores an image display processing program as described later, and functions as an image display processing apparatus. The game apparatus 10 includes a first liquid crystal display (LCD) 12 and a second LCD 14. The LCD 12 and the LCD 14 are provided on a housing 16 so as to be arranged in a predetermined position. In this embodiment, the housing 16 is constructed by an upper housing 16a and a lower housing 16b, and the LCD 12 is provided on the upper housing 16a while the LCD 14 is provided on the lower housing 16b. Accordingly, the LCD 12 and the LCD 14 are closely arranged so as to be longitudinally (vertically) parallel with each other.

It is noted that although the LCD is utilized as a display in this embodiment, an EL (Electronic Luminescence) display and a plasma display may be used in place of the LCD.

As can be understood from FIG. 1, the upper housing 16a has a plane shape little larger than a plane shape of the LCD 12, and has an opening formed so as to expose a display surface of the LCD 12 from one main surface thereof. On the other hand, the lower housing 16b has a plane shape horizontally longer than the upper housing 16a, and has an opening formed so as to expose a display surface of the LCD 14 at an approximately center of the horizontal direction. Furthermore, the lower housing 16b is provided with a sound release hole 18 and an operating switch 20 (20a, 20b, 20c, 20d, 20e, 20L and 20R).

In addition, the upper housing 16a and the lower housing 16b are rotatably connected at a lower side (lower edge) of the upper housing 16a and a part of an upper side (upper edge) of the lower housing 16b. Accordingly, in a case of not playing a game, for example, if the upper housing 16a is rotated to fold such that the display surface of the LCD 12 and the display surface of the LCD 14 are face to face with each other, it is possible to prevent the display surface of the LCD 12 and the display surface of the LCD 14 from being damaged such as a flaw, etc. It is noted that the upper housing 16a and the lower housing 16b are not necessarily rotatably connected with each other, and may alternatively be provided integrally (fixedly) to form the housing 16.

The operating switch 20 includes a direction instructing switch (cross switch) 20a, a start switch 20b, a select switch 20c, an action switch (A button) 20d, an action switch (B button) 20e, an action switch (L button) 20L, and an action switch (R button) 20R. The switches 20a, 20b and 20c are placed at the left of the LCD 14 on the one main surface of the lower housing 16b. Also, the switches 20d and 20e are placed at the right of the LCD 14 on the one main surface of the lower housing 16b. Furthermore, the switches 20L and 20R are placed in a part of an upper edge (top surface) of the lower housing 16b at a place except for a connected portion, and lie of each side of the connected portion with the upper housing 16a.

The direction instructing switch 20a functions as a digital joystick, and is utilized for instructing a moving direction of a player character (or player object) to be operated by a user, instructing a moving direction of a cursor, and so forth by operating at least any one of four depression portions. The start switch 20b is formed by a push button, and is utilized for starting (restarting), temporarily stopping (pausing) a game, and so forth. The select switch 20c is formed by the push button, and utilized for a game mode selection, etc.

The action switch 20d, that is, the A button 20d is formed by the push button, and allows the player character to perform an arbitrary action except for instructing the direction, such as hitting (punching), throwing, holding (obtaining), riding, jumping, etc. For example, in an action game, it is possible to apply an instruction of jumping, punching, moving arms, etc. In a role-playing game (RPG) and a simulation RPG, it is possible to apply an instruction of obtaining an item, selecting and determining arms or command, etc. The action switch 20e, that is, the B button 20e is formed by the push button, and is utilized for changing a game mode selected by the select switch 20c, canceling an action determined by the A button 20d, and so forth.

The action switch 20L (L button) and the action switch 20R (R button) are formed by the push button, and the L button 20L and the R button 20R can perform the same operation as the A button 20d and the B button 20e, and also function as a subsidiary of the A button 20d and the B button 20e.

Also, on a top surface of the LCD 14, a touch panel 22 is provided. As the touch panel 22, any one of a resistance film system, an optical system (infrared rays system) and an electrostatic capacitive coupling system, for example, can be utilized. When being operated by depressing, stroking, touching, and so forth (touch operation) with a stick 24, a pen (stylus pen), or a finger (hereinafter, referred to as “stick 24, etc.”) on a top surface thereof, the touch panel 22 detects coordinates of the position as to the touch operation (touch coordinate) by the stick 24, etc., and outputs coordinate data corresponding to the detected touch coordinates.

In this embodiment, a resolution of the display surface of the LCD 14 is 256 dots×192 dots (this is true or roughly true for the LCD 12), and a detection accuracy of the touch panel 22 is also rendered 256 dots×192 dots in correspondence to the resolution of the display surface. It is noted that detection accuracy of the touch panel 22 may be lower than the resolution of the display surface, or higher than it.

Different game image (game screens) may be displayed on the LCD 12 and the LCD 14. For example, in a racing game, a screen viewed from a driving seat is displayed on the one LCD, and a screen of entire race (course) may be displayed on the other LCD. Furthermore, in the RPG, characters such as a map, a player character, etc. are displayed on the one LCD, and items belonging to the player character may be displayed on the other LCD. Furthermore, in a puzzle game, an entire puzzle (entire virtual space) is displayed on the one LCD (LCD 12, for example), and a part of the virtual space can be displayed on the other LCD (LCD 14, for example). For example, as to the screen displaying a part of the virtual space, it is possible to render an image such as a texture, figure, etc. and move a display image (icon), etc. In addition, by utilizing the two LCD 12 and LCD 14 as one screen, it is possible to display a large monster (enemy character) to be defeated by the player character.

Accordingly, the user is able to point a character image such as a player character, an enemy character, an item character, texture information, an icon, etc. to be displayed on the LCD 14 and select commands and render text, or a figure (image) by operating the touch panel 22 with the use of the stick 24, etc. Furthermore, it is possible to change the direction of the virtual camera (view point) provided in the two-dimensional game space, and instruct a scrolling (gradual moving display) direction of the game screen (game map, etc.).

Thus, the game apparatus 10 has the LCD 12 and the LCD 14 as a display portion of two screens, and by providing the touch panel 22 on an upper surface of any one of them (LCD 14 in this embodiment), the game apparatus 10 has the two screens (12, 14) and the operating portions (20, 22) of two systems.

Furthermore, in this embodiment, the stick 24 can be inserted into a housing portion (housing slot) 26 provided in proximity to a side surface (right side surface) of the upper housing 16a, for example, and taken out therefrom as necessary. It is noted that in a case of preparing no stick 24, it is not necessary to provide the housing portion 26.

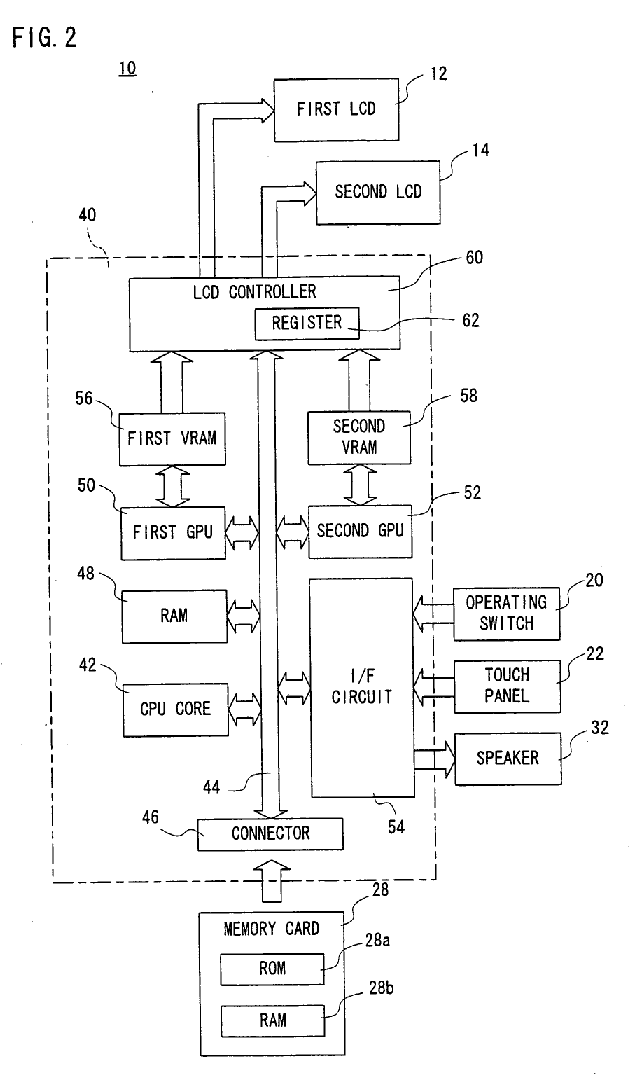

Also, the game apparatus 10 includes a memory card (or game cartridge) 28. The memory card 28 is detachable, and inserted into a loading slot 30 provided on a rear surface or a lower edge (bottom surface) of the lower housing 16b. Although omitted in FIG. 1, a connector 46 (see FIG. 2) is provided at a depth portion of the loading slot 30 for connecting a connector (not shown) provided at an end portion of the memory card 28 in the loading direction, and when the memory card 28 is loaded into the loading slot 30, the connectors are connected with each other, and therefore, the memory card 28 is accessible by a CPU core 42 (see FIG. 2) of the game apparatus 10.

It is noted that although not illustrated in FIG. 1, a speaker 32 (see FIG. 2) is provided at a position corresponding to the sound release hole 18 inside the lower housing 16b.

Furthermore although omitted in FIG. 1, for example, a battery accommodating box is provided on a rear surface of the lower housing 16b, and a power switch, a volume switch, an external expansion connector, an earphone jack, etc. are provided on a bottom surface of the lower housing 16b.

FIG. 2 is a block diagram showing an electrical configuration of the game apparatus 10. Referring to FIG. 2, the game apparatus 10 includes an electronic circuit board 40, and on the electronic circuit board 40, a circuit component such as a CPU core 42, etc. is mounted. The CPU core 42 is connected to the connector 46 via a bus 44, and is connected with a RAM 48, a first graphics processing unit (GPU) 50, a second GPU 52, and an input-output interface circuit (hereinafter, referred to as “I/F circuit”) 54, and an LCD controller 60.

The connector 46 is detachably connected with the memory card 28 as described above. The memory card 28 includes a ROM 28a and a RAM 28b, and although illustration is omitted, the ROM 28a and the RAM 28b are connected with each other via a bus and also connected with a connector (not shown) to be connected with the connector 46. Accordingly, the CPU core 42 gains access to the ROM 28a and the RAM 28b as described above.

The ROM 28a stores in advance a game program for a game (virtual game) to be executed by the game apparatus 10, image data (character image, background image, item image, icon (button) image, message image, etc.), data of the sound (music) necessary for the game (sound data), etc. The RAM (backup RAM) 28b stores (saves) proceeding data and result data of the game.

The RAM 48 is utilized as a buffer memory or a working memory. That is, the CPU core 42 loads the game program, the image data, the sound data, etc. stored in the ROM 28a of the memory card 28 into the RAM 48, and executes the loaded game program. The CPU core 42 executes a game process while storing in the RAM 48 data (game data, flag data, etc.) temporarily generated in correspondence with a progress of the game.

It is noted that the game program, the image data, the sound data, etc. are loaded from the ROM 28a entirely at a time, or partially and sequentially as necessary so as to be stored (loaded) into the RAM 48.

Each of the GPU 50 and the GPU 52 forms a part of a rendering means, is constructed by, for example, a single chip ASIC, and receives a graphics command (construction command) from the CPU core 42 to generate game image data according to the graphics command. It is noted that the CPU core 42 applies to each of the GPU 50 and the GPU 52 an image generating program (included in the game program) required to generate the game image data in addition to the graphics command.

Furthermore, the GPU 50 is connected with a first video RAM (hereinafter, referred to as “VRAM”) 56, and the GPU 52 is connected with a second VRAM 58. The GPU 50 and the GPU 52 gains access to the first VRAM 56 and the second VRAM 58 to fetch data (image data: data such as character data, texture, etc.) required to execute the construction command. It is noted that the CPU core 42 writes the image data required for rendering to the first VRAM 56 and the second VRAM 58 through the GPU 50 and the GPU 52. The GPU 50 accesses the VRAM 56 to create the game image data for rendering, and the GPU 52 accesses the VRAM 58 to create the game image data for rendering.

The VRAM 56 and the VRAM 58 are connected to the LCD controller 60. The LCD controller 60 includes a register 62, and the register 62 is formed of, for example, one bit, and stores a value of “0” or “1” (data value) according to an instruction of the CPU core 42. The LCD controller 60 outputs the game image data created by the GPU 50 to the LCD 12, and outputs the game image data rendered by the GPU 52 to the LCD 14 in a case that the data value of the register 62 is “0”. On the other hand, the LCD controller 60 outputs the game image data created by the GPU 50 to the LCD 14, and outputs the game image data rendered by the GPU 52 to the LCD 12 in a case that the data value of the register 62 is “1”.

It is noted that the LCD controller 60 can directly read the image data from the VRAM 56 and the VRAM 58, or read the image data from the VRAM 56 and the VRAM 58 via the GPU 50 and the GPU 52.

The I/F circuit 54 is connected with the operating switch 20, the touch panel 22 and the speaker 32. Here, the operating switch 20 is the above-described switches 20a, 20b, 20c, 20d, 20e, 20L and 20R, and in response to an operation of the operating switch 20, a corresponding operation signal (operation data) is input to the CPU core 42 via the I/F circuit 54. Furthermore, coordinate data from the touch panel 22 is input to the CPU core 42 via the I/F circuit 54. In addition, the CPU core 42 reads from the RAM 48 the sound data necessary for the game such as a game music (BGM), a sound effect or voices of a game character (onomatopoeic sound), etc., and outputs it from the speaker 32 via the I/F circuit 54.

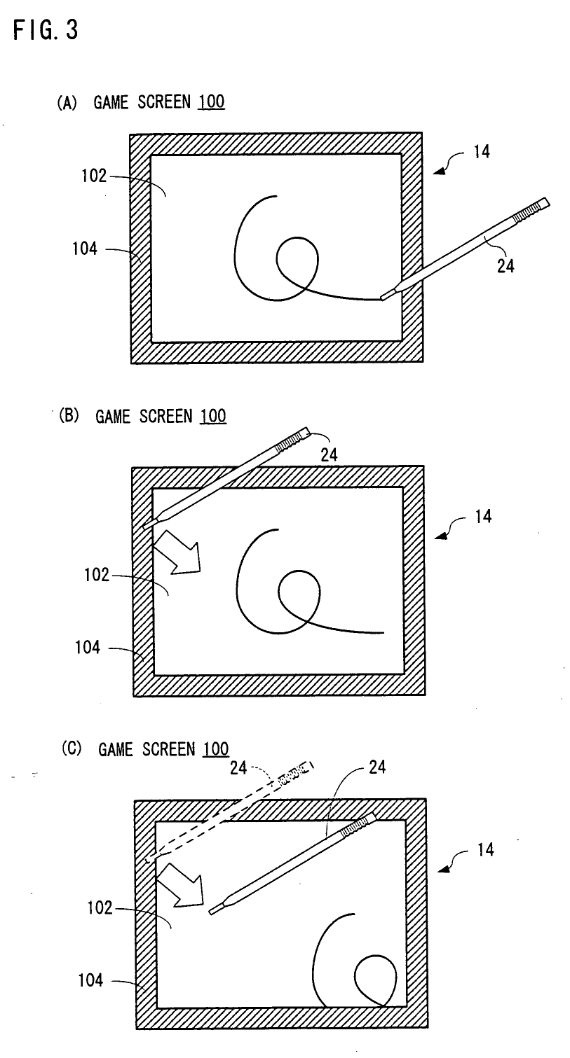

FIG. 3(A) is an illustrative view showing one example of a game screen to be displayed on the LCD 14. In the game screen 100, an area (working area) 102 for displaying texts and lineal drawing (hereinafter referred to as “text, etc.”) is provided. The working area 102 is set so as to be a certain definite range including the center of the display surface of the LCD 14.

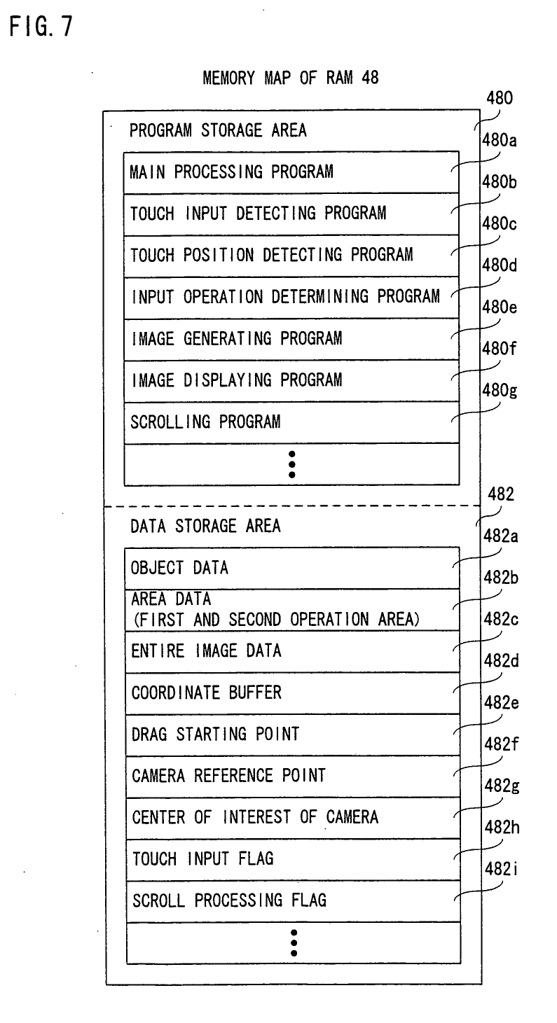

It is noted that the RAM 48 stores image data (entire image data 482c: see FIG. 7) of an area larger than that of the working area (first display area) 102. Then, a part of the image data is read onto the first VRAM 56 or the second VRAM 58 so as to be displayed on the working area 102.

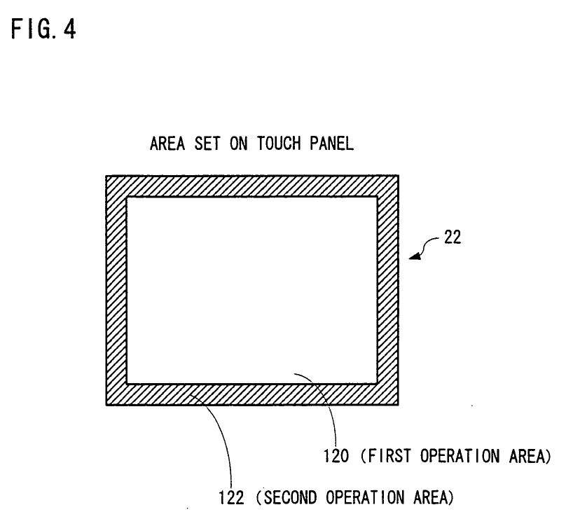

Although omitted in FIG. 3(A)-FIG. 3(C), the touch panel 22 is provided on the LCD 14 as described above, and on the touch panel 22, a first operation area 120 is set in correspondence to the working area 102 as shown in FIG. 4. When the user performs a touch-on (touch input) on the first operation area 120, that is, when the user points the working area 102 at a start of the touch operation, a mode for inputting texts, etc. (input mode) is set. When he or she slides the stick 24 following the touch operation (touch-on), that is, performs a drag operation, it is possible to input (render) the text, etc. according to the drag operation.

For example, when the user performs a stroke operation (drag operation) on the first operation area 120 of the touch panel 22 with the stick 24, etc., a group of the coordinates according to the drag operation is detected on the touch panel 22. The touch panel 22 inputs coordinate data corresponding to each of the coordinate points. The CPU core 42 detects presence or absence of an input to the touch panel 22 for each constant time (one frame: screen update per unit of time ( 1/60 seconds)). That is, the CPU core 42 detects whether or not the touched coordinate, that is, the coordinate data from the touch panel 22 is input for each frame. In a case that the coordinate data is not input from the touch panel 22, even though the screen is updated, the display content is not changed. On the other hand, in a case that the coordinate data is input from the touch panel 22, a line (coordinates (dot) constellation) connecting the coordinates position, that is, the dot of the LCD 14 indicated by the coordinate data and the dot of the LCD 14 indicated by the previous coordinate data is provided in (displayed in) a predetermined color. Accordingly, as shown in FIG. 3(A), the text, etc. is rendered on the LCD 14.

In this embodiment, it is possible to render texts, etc. in the virtual space larger than the working area 102, and as described above, the RAM 48 can store the image data (entire image data 482c) of the virtual space larger than working area 102. Furthermore, dot constellation data (coordinate data group) based on the coordinate data input from the touch panel 22 is stored in the RAM 48. More specifically, the coordinate data input from the touch panel 22 by the CPU 42 is converted into the coordinate data in the virtual space, and the dot constellation data on the basis of the converted coordinate data is stored in the RAM 48. Then, image data as to a partial area (hereinafter referred to as “partial image data”) out of the entire image data 482c stored in the RAM 48 is read onto the VRAM 56 or the VRAM 58, and displayed on the LCD 14. More specifically, the CPU core 42 applies to the GPU 52 an image generating instruction and an image generating program for each frame to allow the GPU 52 to read the dot constellation data of the partial area on the RAM 48 onto the VRAM 56 or the VRAM 58. Then, the CPU core 42 instructs the LCD controller 60 to display an image corresponding to the dot constellation data in the partial area on the LCD 14.

Additionally, the color of the text, etc. to be rendered can be arbitrarily selected by the user. Although illustration is omitted, a menu screen for selecting the color is displayed, so that it is possible to determine the color of the text, etc. for rendering.

As described above, this embodiment is for rendering the text, etc. on the virtual space larger than the working area 102 by rendering the text, etc. in the working area 102. It is noted that as another embodiment, the image data of the virtual space including an icon (button) image is stored in the RAM 48, a partial area of the virtual space is displayed on the working area 102, and when the icon image displayed on the working area 102 is pointed (is subjected to the touch-on), it is also possible to execute a predetermined process set in advance, move the icon image, and so forth. The predetermined process includes a various kinds of processes depending on the games such as causing the player character (not illustrated) to perform an arbitrary action, updating the screen, etc. Furthermore, it may be possible that a part of the virtual space including a moving object such as the player character, the enemy character, etc. is displayed on the working area 102, and by touching the player character and the enemy character displayed on the working area 102, a process set in advance is executed.

In addition, as shown in FIG. 3(A)-FIG. 3(C), a scroll starting area (second display area) 104 is set on a game screen 100 such that it surrounds the working area 102. Corresponding to the scroll starting area 104, a second operation area 122 is set on the touch panel 22 as shown in FIG. 4. The scroll starting area 104 is an area for shifting from a mode for inputting the text, etc.(input mode) to a mode for changing (scrolling in this embodiment) an image (screen) displayed on the working area 102. In addition, as to the scroll starting area 104, a predetermined image (black image, for example) is fixedly displayed on the LCD 14 (game screen 100), and is never scrolled unlikely to the screen to be displayed on the working area 102. That is, the scroll starting area 104 is viewable by the user.

It is noted that in this embodiment, the working area 102, that is, the first operation area 120 is a rectangular area, and the scroll starting area 104, that is, the second operation area 122 is arranged so as to surround it. However, in another embodiment, the working area 102, that is, the first operation area 120 may be a circle area or a oval area, and the scroll starting area 104, that is, the second operation area 122 is arranged so as to surround it.

For example, when a touch input (touch-on) is performed on the scroll starting area 104, that is, when the second operation area 122 in a no-input state (touch-off) state, a mode for scrolling the game screen 100 (scroll mode) is set. That is, the input mode is shifted to the scroll mode. More specifically, as shown in FIG. 3(B), when a touch-on is performed on the working area 102, that is, the second operation area 122, the scroll mode is set. Then, when the user performs the touch-on operation, and then slides the stick 24, that is, performs a drag operation as shown by a hollow arrow in FIG. 3(C), the game screen 100 (strictly, the screen displayed on the working area 102) is scrolled according to the drag operation. More specifically, the position of the display area to be displayed on the working area 102 out of the image data of the virtual space (entire area) stored in the RAM 48, that is, the entire image data 482c is moved according to the drag operation. In this embodiment, a scrolling direction is the same as the moving direction (dragging direction) of the stick 24 by the drag operation. Additionally, the amount of the scroll is equal to a length (distance) of the drag operation, or a length (distance) obtained by multiplying the drag operation by a predetermined ratio. Although illustration is omitted, when the drag operation is ended, that is, when the touch-off is performed, a scroll mode is shifted to the input mode.

It is noted that once that the scroll mode is set, the text, etc. is never input (displayed) irrespective of the drag operation of the working area 102 until cancellation (touch-off), and therefore, the scroll is executed (continued).

Furthermore, in a case that the user renders the text, etc. in the input mode, and enters the stick 24 into the scroll starting area 104 from the working area 102, the input mode is maintained without being changed to the scroll mode. That is, as described above, only when the touch-on is performed on the scroll starting area 104 in the touch-off state, the scroll mode is set.

It is noted that in a case that the user renders the text, etc. in the input mode, and enters the stick 24 into the scroll starting area 104 from the working area 102 and keeps the stick 24 on the scroll starting area 104 for a constant period, the input mode may be changed to the scroll mode.

In addition, in this embodiment, only the part of the entire image data 482c stored in the RAM 48 (partial image data) is displayed on only the working area 102, and the partial image data displayed on the working area 102 is made to be scrolled. It is noted that as another embodiment, the partial image data of the entire image data 482c stored in the RAM 48 is displayed in the area (display area of the LCD 14) combining the working area 102 and the scroll starting area 104 area, and when the player performs a touch-on operation on the scroll starting area 104 (second operation area 122), and then performs a drag operation, the partial image data displayed on the area combining the working area 102 and the scroll starting area 104, that is, the display area may be scrolled. In this case, in the scroll starting area 104, a translucent image is fixedly displayed, and the partial image data can be displayed so as to pass through the translucent image in the scroll starting area 104. Thus, it becomes possible to set the scroll starting area 104 without making the area displaying the partial image data narrower. That is, it is possible to effectively use the display area (display surface) of the LCD 14.

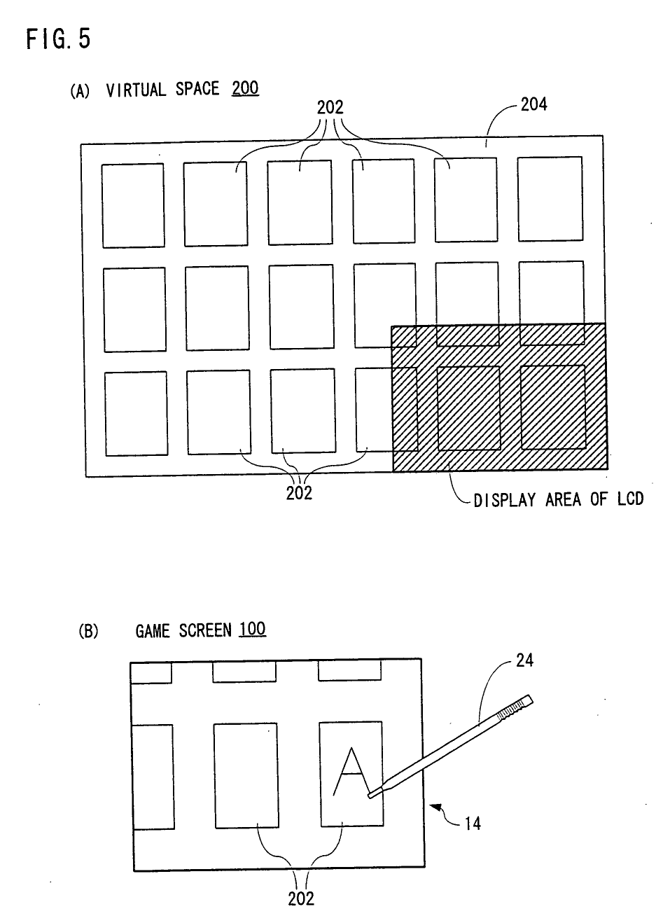

For example, in the game apparatus 10 of this embodiment, it is possible to play a puzzle game such as a crossword. It is noted that the puzzle game may be another game without being limited to the crossword. Example is a puzzle game provided in the web page by Nikoli Co. Ltd. (http://www.nikoli.co.jp/puzzle/). As shown in FIG. 5(A), in a virtual space 200 as to the puzzle game, a plurality of text input areas 202 (18, here) and a background object 204 are provided. For example, a part of the area (partial area) of the virtual space 200 shown by a diagonally shaded bounding rectangle (display range (display area) of the LCD 14) in FIG. 5(A) is displayed on the LCD 14 as the game screen 100 as shown in FIG. 5(B). It is noted that although for simplicity, the working area 102 and the scroll starting area 104 are omitted in FIG. 5(B), they are fixedly set as shown in FIG. 3(A) and FIG. 3(B). In addition, the size of the partial area (range) is set in advance depending on the size of the display surface of the LCD 14 by a developer and a programmer of the game.

It is noted that in a case that the entire virtual space 200 shown in FIG. 5(A) is displayed on the LCD 12, the user can display a desired screen on the working area 102 by scrolling the game screen 100 displayed on the LCD 14 in a desired direction by viewing the virtual space 200, for example, an entire portion of the puzzle. In such a case, the entire image data 482c is reduced (thinned-out), read onto the VRAM 56 or the VRAM 58, and displayed on the LCD 12.

As described above, in a case that the user performs a touch-on operation on the first operation area 120 (working area 102) with the use of the stick 24, and then performs a drag operation, he or she can render the text, etc. More specifically, in a case that the touch-on is performed on the first operation area 120 (text input areas 202), it is possible to render the text, etc. FIG. 5(B) shows a game screen 100 with a text (a character of alphabet “A”, here) in a certain text input areas 202 rendered by the user.

It is noted that even if a touch-on is performed on the first operation area 120, if the touch on is performed at the position where the background object 204 is displayed, it is impossible to render a text, etc.

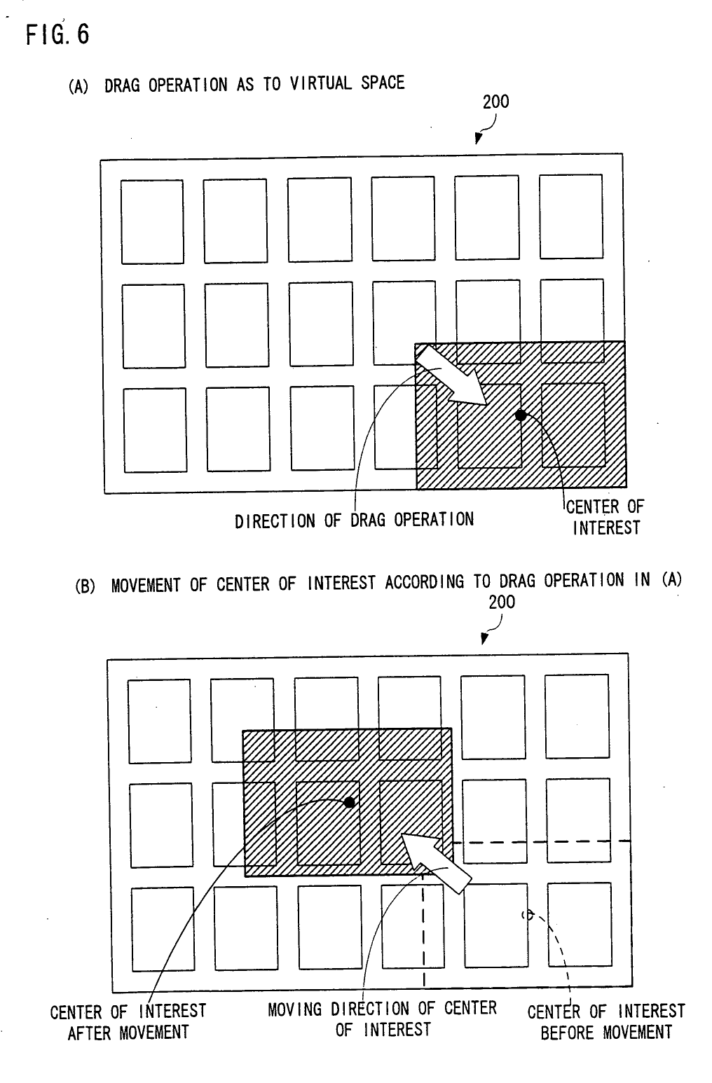

Furthermore, in a case that the user performs a touch-on on the second operation area 122 (scroll starting area 104) with the use of the stick 24, and successively performs a drag operation, he or she can scroll the game screen 100, that is, the working area 102. That is, it is possible to move a partial area displayed on the LCD 14 out of the virtual space 200. FIG. 6(A) is a conceptual rendering showing a drag operation on the virtual space 200 by the user. In addition, FIG. 6(B) is an illustrative view showing a state of moving a center of interest of the virtual camera (not illustrated) provided in the virtual space 200 according to the drag operation shown in FIG. 6(A). When the user performs a touch-on operation on the second operation area 122 (scroll starting area 104) with the use of the stick 24, and then performs a drag operation in a diagonally downward right direction as shown in FIG. 6(A), the center of interest of the virtual camera is accordingly moved (changed) in the reverse direction to the drag direction, that is, the diagonally upward left direction as shown in FIG. 6(B). It is noted that the scroll amount is equal to the distance (length) of the drag operation, or the distance obtained by multiplying the drag operation by a predetermined ratio as described above, and therefore, the moving amount of the center of interest is equal to the length (distance) of the drag operation or the distance obtained by multiplying the drag operation by the predetermined ratio.

It is noted that although illustration is omitted, at a start of the game, the center of interest is set at the central position of the virtual space 200, for example, and therefore, a partial area including the center of the virtual space 200 is displayed on the LCD 14 as the game screen 100.

As described above, the coordinate data is detected for each frame, and therefore, the drag operation is detectable for each frame. In addition, the game screen 100 is updated for each frame. Accordingly, scroll of the screen according to the drag operation has to be executed for each frame.

For example, where a touched coordinate at a start of performing a drag operation (in the touch-on state) shall be P1 (x1, y1), and a touched coordinate detected for each frame until the touch-off (end of the drag operation) shall be P2 (x2, y2), a vector P12/ (“/” means vector) of the drag operation taking the starting time as the reference (starting point) can be calculated according to the equation 1.
P12/=(x2−x1, y2−y1) [equation 1]

The direction reverse to the direction of the vector P12/ is the direction of the vector taking the camera reference point as the starting point and taking the center of interest after movement as the end point. Here, the camera reference point means the center of interest (before movement) of the virtual camera at a start of scrolling. Furthermore, the position of the center of interest after movement is determined to be a point moved from the camera reference point in a reverse direction to the vector P12/ by scalar of the vector P12/, or a length obtained by multiplying the scalar by a predetermined ratio. More specifically, the moving amount (moving amount Dx in the X-axis direction, moving amount Dy in the Y-axis direction) from the camera reference point is calculated according to the equation 2.
D=√{(Dx)²+(Dy)²} [equation 2]
Dx=−(x2−x1)×α
Dy=−(y2−y1)×α

It is noted that α is the above-described predetermined ratio. Accordingly, if a ratio α is set to 1, the moving amount D of the center of interest is set so as to be equal to the length of the drag operation. If the value of the ratio α is set to be larger than 1, the moving amount D of the center of interest is set to be longer than the distance of the drag operation. Furthermore, if the value of the ratio α is set to be smaller than 1 (noted, α>0), the moving amount D of the center of interest is set to be shorter than the distance of the drag operation. The value of the ratio α can be set by a programmer or developer of the game (puzzle game in this embodiment) in advance, and can further be arbitrarily set (changed) on the menu screen, etc. by the user.

Thus, the user updates the center of interest according to the drag operation, and therefore, the game screen 100 to be displayed on the LCD 14, that is, the screen to be displayed on the working area 102 is scrolled in correspondence to the direction and the distance of the drag operation.

It is noted that the screen to be displayed on the working area 102 is scrolled by changing the center of interest of the virtual camera in this embodiment. However, by changing a reference coordinate (position at the upper left corner of the working area 102, for example) of a partial area to be displayed in the working area 102 out of the entire image data 482c stored in the RAM 48, the partial area to be displayed in the working area 102, that is, the screen may be scrolled.

Furthermore, in this embodiment, on the basis of the vector P12/ that directs from the touched coordinates P1 (x1, y1) at a time of the touch-on and the touched coordinates P2 (x2, y2) until the touch-off, the center of interest of the camera is moved in the reverse direction to the vector P12/ taking a position of the center of interest of the camera at a touch-on as a reference. However, as another embodiment, on the basis of the vector P12/′ directing from the touched coordinate detected at a certain frame n to the touched coordinate detected at a next frame n+1, the center of interest of the camera may be moved to the reverse direction to the vector P12/′ taking the position of the center of interest of the camera at the frame n as a reference.

FIG. 7 is an illustrative view showing one example a memory map of the RAM 48 shown in FIG. 2. With referring to FIG. 7, the RAM 48 includes a program storage area 480 and a data storage area 482. The program storage area 480 stores a game program (including image display processing program), and the game program is constructed by a main processing program 480a, a touch input detecting program 480b, a touch position detecting program 480c, a input operation determining program 480d, an image generating program 480e, an image displaying program 480f, and a scrolling program 480g, etc.

The main processing program 480a is a program for processing a main routine of the virtual game. The touch input detecting program 480b is a program for detecting presence or absence of the touch input for each constant time (one frame), and turning on (establishing)/off (unestablishing) a touch input flag 482h described later. In addition, the touch input detecting program 480b is a program for storing (temporarily storing), when there is a touch input, the coordinate data input from the touch panel 22 in response to the touch input in a coordinate buffer 482d described later. It is noted that the presence or absence of the touch input is determined depending on whether or not the coordinate data is input form the touch panel 22.

The touch position detecting program 480c is a program for determining in which area the touched coordinate (touched position) indicated by the coordinate data detected according to the touch input detecting program 480b is included, the first operation area 120 and the second operation area 122. More specifically, the CPU core 42 detects in which area the touched coordinate is included, the first operation area 120 or the second operation area 122 with reference to area data 482b described later.

The input operation determining program 480d is a program for determining whether or not the touch input by the user is a scroll operation. As described above, in the input mode, the touch-off state is shifted to the touch-on state. In a case that the touched coordinate at this time is included in the second operation area 122, it is determined that a scroll operation is started, and whereby the scroll mode is set. The scroll mode is cancelled when the touch-on state is shifted to the touch-off state. That is, the input mode is set.

The image generating program 480e is a program for generating (rendering) an image of a background object and a character (icon, text, design, sign, etc.) by use of object data 482a described later, and generating (rendering) an image including a text, etc. to be rendered by the user. The image displaying program 480f is a program for displaying the image generated according to the image generating program 480e on the LCD 12 or the LCD 14. The scrolling program 480g is a program fro scrolling the screen to be displayed on the working area 102.

It is noted that although illustration is omitted, the program storage area 480 also stores a sound reproducing program, a backup program, etc. The sound reproducing program is a program for reproducing a sound (music) necessary for the virtual game. The backup program is a program for storing (saving) proceeding data or result data generated in correspondence to the proceeding of the virtual game in the RAM 28b of the memory card 28.

The data storage area 482 stores the object data 482a, the area data 482b, and the entire image data 482c. The object data 482a is data (polygon data, texture data, etc.) for generating images of the background object and the character. The area data 482b is a coordinate data group as to a plurality of coordinates (dots) included in the first operation area 120 and the second operation area 122 set with respect to the touch panel 22. The area data 482b is separately stored as the coordinate data group of the first operation area 120 and the coordinate data group of the second operation area 122. It is noted that in this embodiment, the detection surface of the touch panel 22 is divided into two of the first operation area 120 and the second operation area 122, and therefore, where one of the coordinate data group of the first operation area 120 and the coordinate data group of the second operation area 122 is stored, it is apparent that the coordinate data that is not included in the one coordinate data group belongs to the other coordinate data groups. It is noted that the area data 482b may be equation data, etc. for determining whether or not the coordinates of the touch panel 22 belongs to which area. The entire image data 482c is image data corresponds to the entire virtual space 200 described above, and is utilized for displaying the entire virtual space 200 on the LCD 12 (in a reduced manner), and displaying the partial area on the LCD 14 as a game screen 100.

Furthermore, the data storage area 482 is provided with a coordinate buffer 482d, and the coordinate buffer 482d stores (temporarily stores) the coordinate data detected according to the touch input detecting program 480b. Additionally, the data storage area 482 stores coordinate data at a start of drag (starting point data) 482e, coordinate data of the camera reference point (reference point data) 482f, and coordinate data of the center of interest of the camera (center of interest data) 482g. The starting point data 482e is coordinate data input from the touch panel 22 at a time when it is determined to be a start of the scrolling out of the coordinate data stored in the coordinate buffer 482d, and the coordinate data is copied. The reference point data 482f is coordinate data as to the center of interest of the virtual camera at a time when it is determined to be a start of the scrolling. The center of interest data 482g is coordinate data as to the current center of interest of the virtual camera.

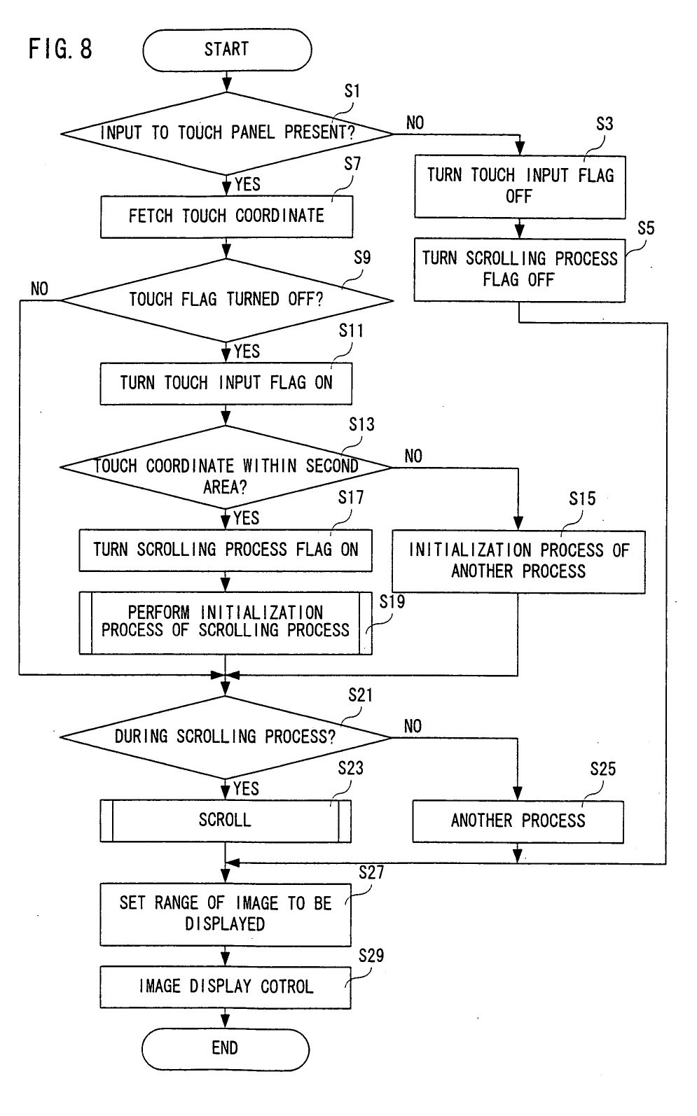

In addition, the data storage area 482 stores the touch input flag 482h and the scrolling process flag 482i. The touch input flag 482h is a flag that is turned on/off according to the touch input detecting program 480b as described above, and the flag 482h is turned on when there is a touch input (touch-on), and the flag 482h is turned off where there is no touch input (touch-off). For example, the touch input flag 482h is formed of one-bit register, and where the flag 482h is turned on, the data value “1” is set to the register, and where the flag 482h is turned off, the data value “0” is set to the register. Furthermore, the scrolling process flag 482i is a flag for determining whether or not to be during scrolling, and turned on/off in a touch panel determining process (see FIG. 8) described later. Where it is during scrolling, the scrolling process flag 482i is turned on, and where it is not during scrolling, the flag 482i is turned off. The scrolling process flag 482i also formed of one-bit register, and where the flag 482i is turned on, the data value “1” is set to the register, and where the flag 482i is turned off, the data value “0” is set to the register.

It is noted that although illustration is omitted, the data storage area 482 stores other data such as sound (music) data, game data (proceeding data, result data), etc. and other flags such as an event flag, etc.

The CPU core 42 shown in FIG. 2 processes an operation as described above according to a flowchart shown in FIG. 8. The flowchart shown in FIG. 8 shows an image displaying process, and also executes a game main process (not illustrated) in addition to the process. The game main process is a process for determining whether or not the text rendered in the text input area 202, for example, is a correct text, or for applying a score according thereto.

Referring to FIG. 8, when starting the image displaying process, the CPU core 42 determines whether or not there is an input to the touch panel 22 in a step S1. If “NO” in the step S1, that is, if there is no input to the touch panel 22, it is determined that it is in a touch-off state, the touch input flag 482h is turned off in a step S3, the scrolling process flag 482i is turned off in a step S5, and then, the process proceeds to a step S27. It is noted that although illustration is omitted, when the scrolling process flag 482i is turned off, the scroll mode is shifted to the input mode.

However, if “YES” in the step S1, that is, if there is an input to the touch panel 22, it is determined that it is in a touch-on state, and the touched coordinate is fetched in a step S7. That is, the detected coordinate data is temporarily stored in the coordinate buffer 482d. In a following step S9, it is determined whether or not the touch input flag 482h is turned off. More specifically, in the step S9, it is determined whether or not the touch-on state continues, or the touch-off state is shifted to the touch-on state. If “NO” in the step S9, that is, if the touch input flag 482h is turned on, it is determined that the touch-on state continues, and the process directly proceeds to a step S21. On the other hand, if “YES” in the step S9, that is, if the touch input flag 482h is turned off, it is determined that the touch-off state is shifted to the touch-on state, and the touch input flag 482h is turned on in a step S11.

Succeedingly, in a step S13, it is determined whether or not the touched coordinate is within the second operation area 122. More specifically, in the step S13, it is determined whether or not the scroll operation depending on whether or not the touched coordinate indicated by the coordinate data detected in the step S7 is included in the second operation area 122 with reference to the area data 482b. If “NO” in the step S13, that is, if the touched coordinate is within the first operation area 120, it is determined that it is not the scroll operation, an initialization process of another process is executed in a step S15, and then, the process proceeds to the step S21. In this embodiment, in the step S15, an initialization process in the input mode is executed. More specifically, the rendering coordinate (variable) is initialized at a current touched coordinate. That is, the current touched coordinate is substituted into the rendering coordinate (hereinafter referred to as “current rendering coordinate” for the sake of explanation).

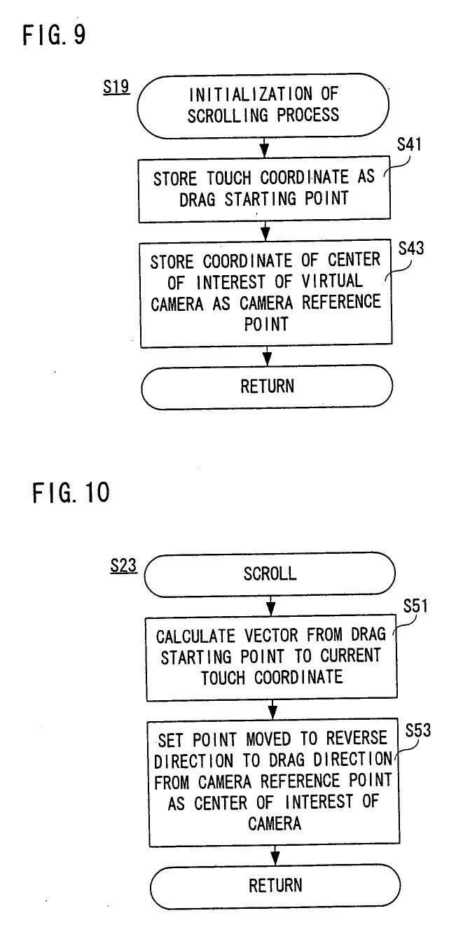

However, if “YES” in the step S13, that is, if the touched coordinate is in the second operation area 122, it is determined that the scroll operation is started, and the scrolling process flag 482i is turned on in a step S17. Then, an initialization process of the scrolling process (see FIG. 9) described later is executed in a step S19, and the process proceeds to the step S21. That is, in the step S17, the scroll mode is set.

In the step S21, it is determined whether or not it is during the scrolling process. That is, it is determined whether or not the scrolling process flag 482i is turned on. If the scrolling process flag 482i is turned on, “YES” is determined in the step S21, and a scrolling process (see FIG. 10) described later is executed in a step S23. Then, the process proceeds to the step S27. However, if the scrolling process flag 482i is turned off, another process is executed in a step S25, and then, the process proceeds to the step S27. More specifically, in the step S25, a previous (before one frame) rendering coordinate is stored, and a newest touched coordinate is fetched as a current rendering coordinate. That is, both the current rendering coordinate and the previous rendering coordinate are updated. Then, the previous rendering coordinate and the current rendering coordinate are connected with a straight line. It is noted that strictly speaking, a process of connecting the previous rendering coordinate and the current rendering coordinates is executed on the VRAM 56 by the GPU50 or on the VRAM 58 by the GPU 52, and the CPU core 42 merely applies an instruction for the process.

In the step S27, a range of an image to be displayed is set. That is, a predetermine range, that is, a partial area (partial image data) taking the center of interest of the virtual camera as the center out of the virtual space 200 (entire image data 482c) is read onto the VRAM 56 or the VRAM 58. At this time, if the text, etc. is input, or the icon, etc. is pointed or moved by the other process (S25) as described above, the content thereof is also reflected. Then, in a step S29, an image display control is executed, and then, the image displaying process is ended. More specifically, in the step S29, an instruction of displaying an image is applied to the LCD controller 60, and in response thereto, the LCD controller 60 outputs the partial image data that has been read onto the VRAM 56 or the VRAM 58 in the step S27 to the LCD 14. Accordingly, the game screen 100 is displayed.

It is noted that the image displaying process shown in FIG. 8 is executed for each frame, and therefore, by the process in the step S27 and S29, an input of the text, etc. and scrolling of the screen are reflected on the game screen 100 to be updated for each frame.

FIG. 9 is a flowchart showing an initialization process of the scrolling. Referring to FIG. 9, when the CPU core 42 starts the initialization process of scrolling, the touched coordinate is stored as the drag starting point in a step S41. That is, the coordinate data stored in the coordinate buffer 482d in the step S7 is stored (copied) as the starting point data 482e in the data storage area 482. In a succeeding step S43, the coordinate of the center of interest of the virtual camera (center of interest coordinates) is stored as a camera reference point, and then, the initialization of the scrolling process is returned. That is, in the step S43, the center of interest data 482g is stored (copied) as the reference point data 482f.

FIG. 10 is a flowchart showing a scrolling process. Referring to FIG. 10, when the CPU core 42 starts the scrolling process, it calculates a vector from the drag starting point to the current touched coordinate in a step S51. That is, a vector taking the coordinate indicated by the starting point data 482e as the starting point and taking the current touched coordinate as the end point is calculated. It is noted that at a start of scrolling, the drag starting point and the current touched coordinate are coincident with each other, and therefore, the vector is not calculated by the process in the step S51. In a succeeding step S53, a point that has been moved in a reverse direction to the drag direction from the camera reference point is set as the center of interest of the virtual camera (center of interest of the camera), and then, the scrolling process is returned. That is, in the step S53, the center of interest of the camera is moved in a direction reverse to the direction of the vector calculated according to the equation 1 in the step S51 by a dimension equal to the scalar of the vector (distance) or by a dimension obtained by multiplying the scalar of the vector by the predetermined ratio. It is noted that the moving amount D of the center of interest of the camera is calculated according to the equation 2. That is, in the step S53, the center of interest data 482g is updated. Accordingly, the range (area) of the virtual space 200 shot by the virtual camera is changed, and whereby, the screen to be displayed on the working area 102 is scrolled in the drag direction.

According to the embodiment, the screen is scrolled in the direction of the drag operation by the user, and therefore, it is possible to scroll the screen in an arbitrary direction. Furthermore, in a case that a touch-on is performed on the scroll starting area, scrolling is started, and in a case that a touch-on is performed on the working area, it is possible to execute input of texts, etc., facilitating the touch operation. That is, it is possible to improve operability.

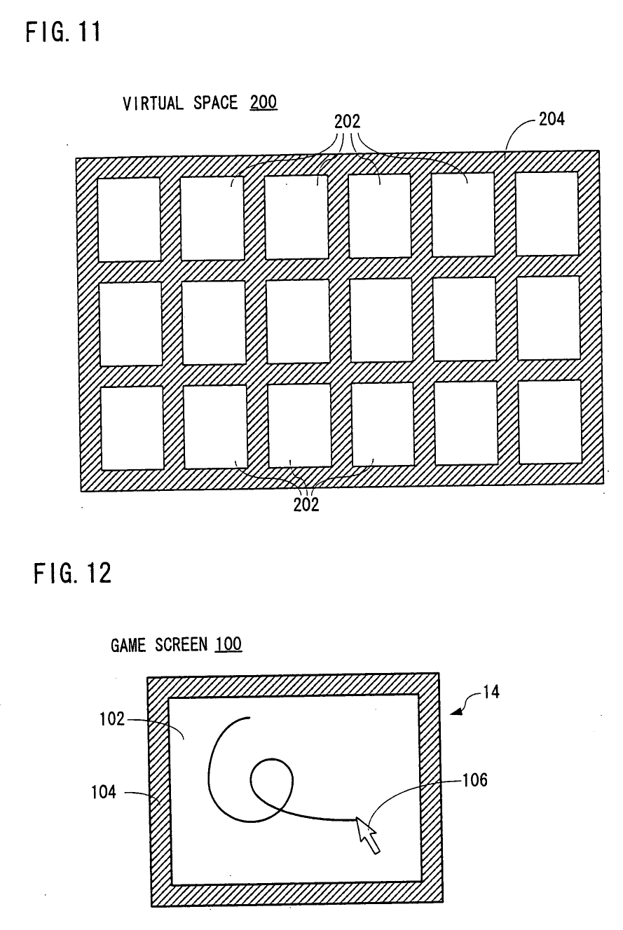

It is noted that in the above-described embodiment, the second operation area is fixedly set to the area corresponding to the scroll starting area on the touch panel, and whereby, it is determined whether or not the scrolling process is executed. However, it may be possible that whether or not the scrolling process is executed is determined depending on the kind of the object on which the touch-on is performed. For example, as shown in FIG. 11, in a case that an area except for the text input areas 202, that is, the area on which the background object 204 is arranged in the virtual space 200 is set as the scroll start area. If a touch-on is performed on the area 204, it is possible to move the center of interest of the virtual camera according to the drag operation, and also scroll the working area 102. In this case, the background object 204 is moved according to the scroll, and therefore, the scroll starting area is also moved. It is noted that in a case that a touch-on is performed on the area except where the background object 204 is arranged, the working area 102 is not scrolled.

Furthermore, although the virtual space is a two-dimensional space in the above-described embodiment, the virtual space may be a three-dimensional space in another embodiment. In this case, it is possible to calculate a moving direction and a moving amount of the center of interest on the basis of the three-dimensional coordinates of a point corresponding to the touched coordinate in the virtual space.

In addition, in the above-described embodiment, the touch panel is utilized as an input device, and the first operation area and the second operation area are set on the touch panel in correspondence to the working area and the scroll starting area, and whereby, it is determined whether or not the touch-on is performed on the working area or the scroll starting area by determining in which area the touched coordinate is included, the first operation area or the second operation area. It is noted that it may be possible that by converting a touched coordinate into a displayed coordinate on the LCD 14, which area is directed, the first operation area and the second operation area is directly detected. In such a case, in the step S13 shown in FIG. 8, it is determined whether or not the touched coordinate (operation position) is included in the scroll starting area.

Furthermore, although a description is made on a case where the touch panel 22 is utilized as an input device in the above-described embodiment, another input device may be utilized. For example, a computer mouse can also be utilized. In such a case, although illustration is omitted, a computer mouse is connected to the game apparatus 10. In addition, as shown in FIG. 12, for example, a so-called mouse pointer 106 is displayed on the game screen 100 of the LCD 14. As well known, the mouse pointer 106 is moved on the game screen 100 according to the operation of the computer mouse. It is noted that an example of the game screen 100 in FIG. 12 shows that the text, etc. is input (rendered) according to the movement of the mouse pointer 106.

For example, in a case of utilizing the computer mouse, when the user starts to perform an input operation, that is, a click-off state is shifted to the click-on state in a state the mouse pointer 106 points the working area 102, an input mode is set. Then, when the user performs a drag operation following the click operation, it becomes possible to input the text, etc. Furthermore, when the user starts an input operation in a state that the mouse pointer 106 points the scroll starting area 104, a scroll mode is set. When the user performs a drag operation following to the click-on operation, it becomes possible to scroll the screen to be displayed on the working area 102. When a click-off operation is performed on the mouse pointer 106, the scroll mode is shifted to the input mode. Although illustration is omitted, an input method of the text, etc. and a scrolling method are the same as that of the above-described embodiment.

At a start of the operation input (at a time that the click-off state is shifted to the click-on state), it is determined that in which area a position (operated position) on the LCD 14 indicated by the mouse pointer 106 is included, the working area 102 or the scroll starting area 104, and according to the determination result, it is possible to set the input mode and the scroll mode.

It is noted that in a case that a pointing image such as a mouse pointer 106 is displayed, and according to the movement of the image, the screen is operated. Thus, there is no need to provide the touch panel 22 and the stick 24 in the game apparatus 10.

In addition, in a hand-held type game apparatus 10 shown in the above-described embodiment (FIG. 1), the mouse pointer 106 may be moved (turns at least any one of the button belonging to the cross switch 20a) without utilizing a computer mouse, with the use of the cross switch 20a and the A button 20d, clicked (turns the A button 20d on/off), and dragged (turns at least one of the buttons belonging to the cross switch 20a on, and continued to depress (turn on) the A button 20d).

In addition, in the above-described embodiment, a description is made on a case where the two LCDs are provided to display the two game screens. However, it may be possible that one LCD is provided on which the touch panel is set to display one game screen on the LCD.

Furthermore, in the above-described embodiment, a description is made on a game apparatus provided with the two LCDs. However, one LCD is divided into two working areas, and a touch panel is set on at least any one of the working areas. In this case, in a case of providing a vertically-long LCD, the working area of the LCD is divided into two such that the working areas are vertically arranged with each other, and in a case of a horizontally-long LCD, the working area of the LCD is divided into two such that the working areas are horizontally arranged with each other.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A storage medium storing an image displaying processing program of an image display processing apparatus that is provided with a display for displaying a partial area of a virtual space, and renders, according to an operation input, an image or performs a predetermined process set in advance on a displayed image,
said image display processing program causes a processor of said image display processing apparatus to execute:
an operation position detecting step for detecting an operation position on a screen of said display on the basis of said operation input,
a determining step for determining in which area the operation position detected by said operation position detecting step is included, a first display area or a second display area that is included in a display area of said display,
an image processing step for, when it is determined that said operation position is included in said first display area by said determining step, rendering an image on the basis of said operation position, or performing a predetermined process set in advance on the image corresponding to said operation position, and
a display area moving step for, when it is determined that said operation position is included in said second display area by said determining step, moving an area displayed on said display area out of said virtual space according to the movement of said operation position.

2. A storage medium storing an image display processing program according to claim 1, wherein
said display area moving step determines a moving amount of the area displayed on said display area according to a moving amount of said operation position.

3. A storage medium storing an image display processing program according to claim 1, wherein
said display area moving step moves the area displayed on said display area in a direction reverse to a moving direction of said operation position.

4. A storage medium storing an image display processing program according to claim 1, wherein
said display area moving step moves the area displayed on said display area according to the movement of said operation position only when said operation position at a start of the operation input is included in said second display area.

5. A storage medium storing an image display processing program according to claim 4, wherein
said display area moving step, while the presence of said operation input continues, continues to move the area displayed on said display area according to the movement of said operation position even if said operation position is included in said first display area.

6. A storage medium storing an image display processing program according to claim 1, wherein
a screen relating to an image processing is changeably displayed on said first display area, and
a specific image is fixedly displayed on said second display area.

7. A storage medium storing an image display processing program according to claim 1, wherein
a screen relating to an image processing is changeably displayed on said first display area and said second display area, and
a specific image is displayed on said second display area in a translucent manner.

8. A storage medium storing an image display processing program according to claim 1, wherein
said first display area is set in a certain definite range including a center of the display surface of said display, and
said second display area is set so as to surround said first display area.

9. A storage medium storing an image display processing program according to claim 1, wherein
said image display processing apparatus is further provided with a touch panel provided in association with said display, and
said operation position detecting step detects said operation position corresponding to a touched coordinate detected on the basis of an output from said touch panel.

10. A storage medium storing an image display processing program according to claim 9, wherein
to said touch panel, a first operation area is fixedly set in correspondence to said first display area, and a second operation area is fixedly set in correspondence to said second display area, and
said determining step determines that said operation position is included in said first display area when said touched coordinate is included in said first operation area, and determines that said operation position is included in said second display area when said touched coordinate is included in said second operation area.

11. A storage medium storing an image display processing program of an image display processing apparatus that is provided with a display to display a partial area of a virtual space and a touch panel provided in association with the display, and renders, according to a touch input, an image or performs a predetermined process set in advance on a displayed image,
said image display processing program causes a processor of said image display processing apparatus to execute:
a touched coordinate detecting step for detecting a touched coordinate on the basis of the output from said touch panel,
a determining step for determining in which area the touched coordinate detected by said touched coordinate detecting step is included, a first operation area or a second operation area that is set to said touch panel,
an image processing step for, when it is determined that said touched coordinate is included in said first operation area by said determining step, rendering an image on the basis of said touched coordinate, or performing a predetermined process set in advance on the image corresponding to said touched coordinate, and
a display area moving step for, when it is determined that said touched coordinate is included in said second operation area by said determining step, moving an area displayed on the display area of said display in said virtual space according to the movement of said touched coordinate.

12. A storage medium storing an image display processing program of an image display processing apparatus that is provided with a display to display a partial area of a virtual space and a touch panel provided in association with the display, and renders, according to a touch input, an image in said virtual space or performs a predetermined process set in advance on a displayed image in said virtual space,
said image display processing program causes a processor of said image display processing apparatus to execute:
a first data storing and updating step for storing or updating first data defining a range to be displayed on said display out of said virtual space,
a display data output step for outputting display data to display the partial area of said virtual space on the basis of image data to display said virtual space and said first data,
a display control step for displaying the partial area of said virtual space on said display on the basis of the display data output by said display data output step,
a touched coordinate detecting step for detecting a touched coordinate on the basis of an output from said touch panel,
a determining step for determining in which area the touched coordinate detected by said touched coordinate detecting step is included, a first operation area or second operation area that is set to said touch panel,
an image processing step for, when it is determined that said touched coordinate is included in said first operation area by said determining step, rendering an image on the basis of said touched coordinate in said virtual space by updating the image data to display said virtual space, or performing a predetermined process set in advance on the image corresponding to said touched coordinate within said virtual space, and
a display area moving step for, when it is determined that said touched coordinate is included in said second operation area by said determining step, moving said partial area to be displayed on said display out of said virtual space according to the movement of said touched coordinate by updating said first data by said first data storing and updating step.

13. A storage medium storing an image display processing program of an image display processing apparatus that is provided with a display to display a partial screen in a virtual space in which at least a first object and a second object are arranged, and a touch panel provided in association with said display, and renders, according to a touch input, an image or performs a predetermined process set in advance on a displayed image,
said image display processing program causes a processor of said image display processing apparatus to execute:
a touched coordinate detecting step for detecting a touched coordinate on the basis of an output from said touch panel,
a determining step for determining in which area the touched coordinate detected by said touched coordinate detecting step is included, a first display area arranging said first object or a second display area arranging said second object,
an image processing step for, when it is determined that said touched coordinate is included in said first display area by said determining step, rendering an image on the basis of said touched coordinate, or performing a predetermined process set in advance on the image corresponding to said touched coordinate, and
a display area moving step for, when it is determined that said touched coordinate is included in said second display area by said determining step, moving an area to be displayed on a display area of said display out of said virtual space according to the movement of said touched coordinate.

14. An image display processing apparatus provided with a display to display a partial area of a virtual space, and renders, according to an operation input, an image or performs a predetermined process set in advance on a displayed image comprising:
an operation position detecting means for detecting an operation position on a screen of said display on the basis of said operation input,
a determining means for determining in which area the operation position detected by said operation position detecting means is included, a first display area or a second display area that is included in a display area of said display,
an image processing means for, when it is determined that said operation position is included in said first display area by said determining means, rendering an image on the basis of said operation position, or performing a predetermined process set in advance on the image corresponding to said operation position, and
a display area moving means for, when it is determined that said operation position is included in said second display area by said determining means, moving an area displayed on said display area out of said virtual space according to the movement of said operation position.

15. An image display processing apparatus according to claim 14, wherein
said display area moving means determines a moving amount of the area displayed on said display area according to a moving amount of said operation position.

16. An image display processing apparatus according to claim 14, wherein
said display area moving means moves the area displayed on said display area in a direction reverse to the moving direction of said operation position.

17. An image display processing apparatus according to claim 14, wherein
said display area moving means moves the area displayed on said display area according to the movement of said operation position only when said operation position at a start of the operation input is included in said second display area.

18. An image display processing apparatus according to claim 17, wherein
said display area moving step, while the presence of said operation input continues, continues to move the area displayed on said display area according to the movement of said operation position even if said operation position is included in said first display area.

19. An image display processing apparatus according to claim 14, wherein
an image relating to an image processing is changeably displayed on said first display area, and
a specific image is fixedly displayed on said second display area.

20. An image display processing apparatus according to claim 14, wherein
a screen relating to the image processing is changeably displayed on said first display area and said second display area, and
a specific screen is displayed on said second display area in a translucent manner.

21. An image display processing apparatus according to claim 14, wherein
said first display area is set in a certain definite range including a center of the display surface of said display, and said second display area is set so as to surround said first display area.

22. An image display processing apparatus according to claim 14, further comprising
a touch panel provided in association with said display, wherein
said operation position detecting means detects said operation position corresponding to a touched coordinate detected on the basis of an output from said touch panel.

23. An image display processing apparatus according to claim 22, wherein
to said touch panel, a first operation area is fixedly set in correspondence to said first display area, and a second operation area is fixedly set in correspondence to said second display area, and
said determining means determines that said operation position is included in said first display area when said touched coordinate is included in said first operation area, and determines that said operation position is included in said second display area when said touched coordinate is included in said second operation area.

24. An image display processing apparatus that is provided with a display to display a partial area of a virtual space and a touch panel provided in association with the display, and renders, according to a touch input, an image or performs a predetermined process set in advance on a displayed image, comprising:
a touched coordinate detecting means for detecting a touched coordinate on the basis of the output from said touch panel,
a determining means for determining in which area the touched coordinate detected by said touched coordinate detecting means is included, a first operation area or a second operation area that is set to said touch panel,
an image processing means for, when it is determined that said touched coordinate is included in said first operation area by said determining means, rendering an image on the basis of said touched coordinate, or performing a predetermined process set in advance on the image corresponding to said touched coordinate, and
a display area moving means for, when it is determined that said touched coordinate is included in said second operation area by said determining means, moving an area displayed on the display area of said display in said virtual space according to the movement of said touched coordinate.

25. An image display processing apparatus that is provided with a display to display a partial area of a virtual space and a touch panel provided in association with the display, and renders, according to a touch input, an image in said virtual space or performs a predetermined process set in advance on the displayed image in said virtual space, comprising:
a first data storing and updating means for storing or updating first data defining a range to be displayed on said display out of said virtual space,
a display data output means for outputting display data to display a partial area of said virtual space on the basis of the image data to display said virtual space and said first data,
a display control means for displaying the partial area of said virtual space on said display on the basis of the display data output by said display data output means,
a touched coordinate detecting means for detecting a touched coordinate on the basis of the output from said touch panel,
a determining means for determining in which area the touched coordinate detected by said touched coordinate detecting means is included, a first operation area or a second operation area that is set to said touch panel,
an image processing means for, when it is determined that said touched coordinate is included in said first operation area by said determining means, rendering an image in said virtual space on the basis of said touched coordinate by updating the image data to display said virtual space, or performing a predetermined process set in advance on the image corresponding to said touched coordinate within said virtual space, and
a display area moving means for, when it is determined that said touched coordinate is included in said second operation area by said determining means, moving said partial area to be displayed on said display out of said virtual space according to the movement of said touched coordinate by updating said first data by said first data storing and updating means.

26. An image display processing apparatus that is provided with a display to display a partial screen in a virtual space in which at least a first object and a second object are arranged and a touch panel provided in association with said display, and renders, according to a touch input, an image or performs a predetermined process set in advance on a displayed image, comprising:
a touched coordinate detecting means for detecting a touched coordinate on the basis of an output from said touch panel,
a determining means for determining in which area the touched coordinate detected by said touched coordinate detecting means is included, a first display area arranging said first object or a second display area arranging said second object,
an image processing means for, when it is determined that said touched coordinate is included in said first display area by said determining means, rendering an image on the basis of said touched coordinate, or performing a predetermined process set in advance the image corresponding to said touched coordinate, and
a display area moving means for, when it is determined that said touched coordinate is included in said second display area by said determining means, moving an area to be displayed on a display area of said display out of said virtual space according to the movement of said touched coordinate.

27. An image displaying method of an image display processing apparatus that is provided with a display for displaying a partial area of a virtual space, and renders, according to an operation input, an image or performs a predetermined process set in advance on a displayed image, comprising following steps of:
(a) detecting an operation position on a screen of said display on the basis of said operation input,
(b) determining in which area the operation position detected by said step (a) is included, a first display area or a second display area that is included in a display area of said display,
(c) rendering an image on the basis of said operation position, or performing a predetermined process set in advance on the image corresponding to said operation position when said operation position is included in said first display area by said step (b), and
(d) moving an area displayed on said display area out of said virtual space according to the movement of said operation position when said operation position is included in said second display area by said step (b).

28. An image display method according to claim 27, wherein
said step (d) determines a moving amount of the area displayed on said display area according to a moving amount of said operation position.

29. An image display method according to claim 27, wherein
said step (d) moves the area displayed on said display area in a direction reverse to the moving direction of said operation position.

30. An image display method according to claim 27, wherein
said display area moving step moves the area displayed on said display area according to the movement of said operation position only when said operation position at a start of the operation input is included in said second display area.

31. An image display method according to claim 30, wherein
said step (d) continues, while the presence of said operation input continues, to move the area displayed on said display area according to the movement of said operation position even if said operation position is included in said first display area.

32. An image display method according to claim 27, wherein
an image relating to an image processing is changeably displayed on said first display area, and
a specific image is fixedly displayed on said second display area.

33. An image display method according to claim 27, wherein
a screen relating to the image processing is changeably displayed on said first display area and said second display area, and
a specific screen is displayed on said second display area in a translucent manner.

34. An image display method according to claim 27, wherein
said first display area is set in a certain definite range including a center of the display surface of said display, and said second display area is set so as to surround said first display area.

35. An image display method according to claim 27, wherein
said image display processing apparatus is further provided with a touch panel provided in association with said display, and
said step (a) detects said operation position corresponding to a touched coordinate detected on the basis of an output from said touch panel.

36. An image display method according to claim 35, wherein
to said touch panel, a first operation area is fixedly set in correspondence to said first display area, and a second operation area is fixedly set in correspondence to said second display area, and
said step (b) determines that said display position is included in said first operation area when said touched coordinate is included in said first operation area, and determines that said operation position is included in said second display area when said touched coordinate is included in said second operation area.

37. An image display method of an image display processing apparatus that is provided with a display to display a partial area of a virtual space and a touch panel provided in association with the display, and renders, according to a touch input, an image or performs a predetermined process set in advance on a displayed image, comprising following steps of:
(a) detecting a touched coordinate on the basis of an output from said touch panel,
(b) determining in which area the touched coordinate detected by said step (a) is included, a first operation area or a second operation area that is set to said touch panel,
(c) rendering an image on the basis of said touched coordinate, or performing a predetermined process set in advance on the image corresponding to said touched coordinate when it is determined that said touched coordinate is included in said first operation area by said step (b), and
(d) moving an area displayed on the display area of said display in said virtual space according to the movement of said touched coordinate when it is determined that said touched coordinate is included in said second operation area by said step (b).

38. An image display method of an image display processing apparatus that is provided with a display to display a partial area of a virtual space and a touch panel provided in association with the display, and renders, according to a touch input, an image in said virtual space or performs a predetermined process set in advance on the displayed image in said virtual space, comprising following steps of:
(a) storing and updating first data defining a range to be displayed on said display out of said virtual space,
(b) outputting display data to display the partial area of said virtual space on the basis of image data to display said virtual space and said first data,
(c) displaying the partial area of said virtual space on said display on the basis of the display data output by said step (b),
(d) detecting a touched coordinate on the basis of the output from said touch panel,
(e) determining in which area the touched coordinate detected by said step (d) is included, a first operation area or a second operation area that is set to said touch panel,
(f) rendering an image in said virtual space on the basis of said touched coordinate by updating the image data to display said virtual space, or performing a predetermined process set in advance on the image corresponding to said touched coordinate within said virtual space when it is determined that said touched coordinate is included in said first operation area by said step (e), and
(g) moving said partial area to be displayed on said display out of said virtual space according to the movement of said touched coordinate by updating said first data by said first data storing and updating step when it is determined that said touched coordinate is included in said second operation area by said step (e).

39. An image display method of an image display processing apparatus that is provided with a display to display a partial screen of a virtual space in which at least a first object and a second object are arranged and a touch panel provided in association with said display, and renders, according to a touch input, an image or performs a predetermined process set in advance on the displayed image, comprising following steps of:
(a) detecting a touched coordinate on the basis of an output from said touch panel,
(b) determining in which area the touched coordinate detected by said step (a) is included, a first display area arranging said first object and a second display area arranging said second object,
(c) rendering an image on the basis of said touched coordinate, or performing a predetermined process set in advance on the image corresponding to said touched coordinate when it is determined that said touched coordinate is included in said first display area by said step (b), and
(d) moving an area to be displayed on a display area of said display out of said virtual space according to the movement of said touched coordinate when it is determined that said touched coordinate is included in said second display area by said step (b).
